(19) United States
(12) Patent Application Publication
(10) Pub. No.: US 2021/0149886 A1
(43) Pub. Date: May 20, 2021

(54) PROCESSING A NATURAL LANGUAGE QUERY USING SEMANTICS MACHINE LEARNING

(71) Applicant: salesforce.com, inc., San Francisco, CA (US)

(72) Inventors: Zuye Zheng, San Francisco, CA (US); Srilakshmi Anusha Surepeddi, San Jose, CA (US); Nelson Esteban Acevedo, San Francisco, CA (US)

(21) Appl. No.: 16/908,465

(22) Filed: Jun. 22, 2020

Related U.S. Application Data
(60) Provisional application No. 62/936,345, filed on Nov. 15, 2019.

(51) Int. Cl. G06F 16/242; G06F 16/2453; G06N 20/00

(52) U.S. Cl. CPC G06F 16/243; G06N 20/00; G06F 16/2453

(57) ABSTRACT

A database server in a system supporting a cloud platform may train a machine learning model on a set of reports generated by a tenant. Each report of the set of reports may include a title and a query for one or more data objects associated with the tenant. The database server may identify a data lineage for a data set associated with the tenant, where the data set is stored across multiple data sources and includes at least the one or more data objects. The database server may receive a natural language query associated with the data set and generate a set of candidate queries from the natural language query based on the machine learning model and the data lineage. The database server may select one or more of the candidate queries for display on a user interface based on a ranking of the plurality of candidate queries.

### CROSS REFERENCE

The present Application for Patent claims the benefit of U.S. Provisional Patent Application No. 62/936,345 by ZHENG et al., entitled “PROCESSING A NATURAL LANGUAGE QUERY USING SEMANTICS MACHINE LEARNING,” filed Nov. 15, 2019, assigned to the assignee hereof, and expressly incorporated by reference herein.

### FIELD OF TECHNOLOGY

The present disclosure relates generally to database systems and data processing, and more specifically to processing a natural language query using semantics machine learning.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A user may use the cloud platform to query for a tenant's data and extract meaningful information. In some systems, the user may use a specific format or specific terms to query the tenant's data. Some systems for data querying can be improved.

### BRIEF DESCRIPTION OF THE DRAWINGS

FIG. 1 illustrates an example of a system for wireless communications that supports processing a natural language query using semantics machine learning in accordance with aspects of the present disclosure.

FIG. 2 illustrates an example of a subsystem that supports processing a natural language query using semantics machine learning in accordance with aspects of the present disclosure.

FIG. 3 illustrates an example of a natural language query procedure that supports processing a natural language query using semantics machine learning in accordance with aspects of the present disclosure.

FIG. 4 illustrates an example of a machine learning service procedure that supports processing a natural language query using semantics machine learning in accordance with aspects of the present disclosure.

FIG. 5 illustrates an example of a graph service procedure that supports processing a natural language query using semantics machine learning in accordance with aspects of the present disclosure.

FIG. 6 illustrates an example of a semantic graph that supports processing a natural language query using semantics machine learning in accordance with aspects of the present disclosure.

FIG. 7 illustrates an example of a natural language query processing graph that supports processing a natural language query using semantics machine learning in accordance with aspects of the present disclosure.

FIG. 8 illustrates an example of a user interface that supports processing a natural language query using semantics machine learning in accordance with aspects of the present disclosure.

FIG. 9 shows a block diagram of an apparatus that supports processing a natural language query using semantics machine learning in accordance with aspects of the present disclosure.

FIG. 10 shows a block diagram of a communications manager that supports processing a natural language query using semantics machine learning in accordance with aspects of the present disclosure.

FIG. 11 shows a diagram of a system including a device that supports processing a natural language query using semantics machine learning in accordance with aspects of the present disclosure.

FIGS. 12 through 15 show flowcharts illustrating methods that support processing a natural language query using semantics machine learning in accordance with aspects of the present disclosure.

### DETAILED DESCRIPTION

A tenant of a multi-tenant database may store information and data for users, customers, organizations, etc. in a database. For example, the tenant may manage and store data and metadata for exchanges, opportunities, deals, assets, customer information, and the like. The tenant may query the database in ways to extract meaningful information from the data, which may assist the tenant in future decision making and analysis. In some cases, a report may include the data query and an appropriate title which describes the queried data in terms and conventions often used by the tenant. These reports, queries, and interactions, as well as corresponding metadata, may also be stored in the databases. A user may be able to combine or cross-analyze multiple reports to further extract meaningful data and information.

The techniques described herein support interpreting a natural language query from a user and providing an appropriate data query to the user. The multi-tenant database may already have a large amount of information stored for each tenant, and this information may already be referred to with the terms, conventions, and language that each tenant naturally uses when refer to their data. Therefore, a server may utilize known relationships between stored data and the tenant-specific semantics to interpret the natural language query and return a corresponding data query. The metadata for reports may indicate which queries are relevant for a natural language query as well as how and which data objects to join to obtain the answer for the natural language query.

The techniques described herein may utilize a tenant-specific machine learning model and tenant-specific data lineage map to interpret a natural language query. The machine learning model may be trained on a set of reports generated by the tenant. Each report may include a tenant-given title and a query for data objects of the tenant, which may be used to train the tenant-specific machine learning model to understand questions and queries from the user in the language and terminology of the tenant's organization. A server may generate a semantics graph which indicates a data lineage for all of the tenant's data, showing how the tenant's data is used and how different parts of the tenant's data are associated. The server may therefore leverage the machine learning model and data lineage for the tenant's data to understand what data is requested by a natural language query. With this automated process, a user may not have to create a book of synonyms for the server to understand the user's language and conventions, and the user may not have to manually link those terms to specific data sources to submit queries.

A user associated with a tenant may submit a natural language query via a user interface at a device. The device may, via a cloud network, submit the natural language query to a server which process the natural language query. The server may use the associated tenant-specific machine learning model and data lineage to estimate a set of data queries which may correspond to the natural language query. The data queries may be sent back to the device of the user for display on the user interface. In some cases, the server may identify a ranking for the set of data queries, including a most-likely interpretation of the natural language query. The user may indicate which of the data queries provides the correct dataset for the natural language query, and this feedback may further be used to refine the machine learning model.

Aspects of the disclosure are initially described in the context of an environment supporting an on-demand database service. Aspects of the disclosure are further illustrated by and described with reference to apparatus diagrams, system diagrams, and flowcharts that relate to processing a natural language query using semantics machine learning.

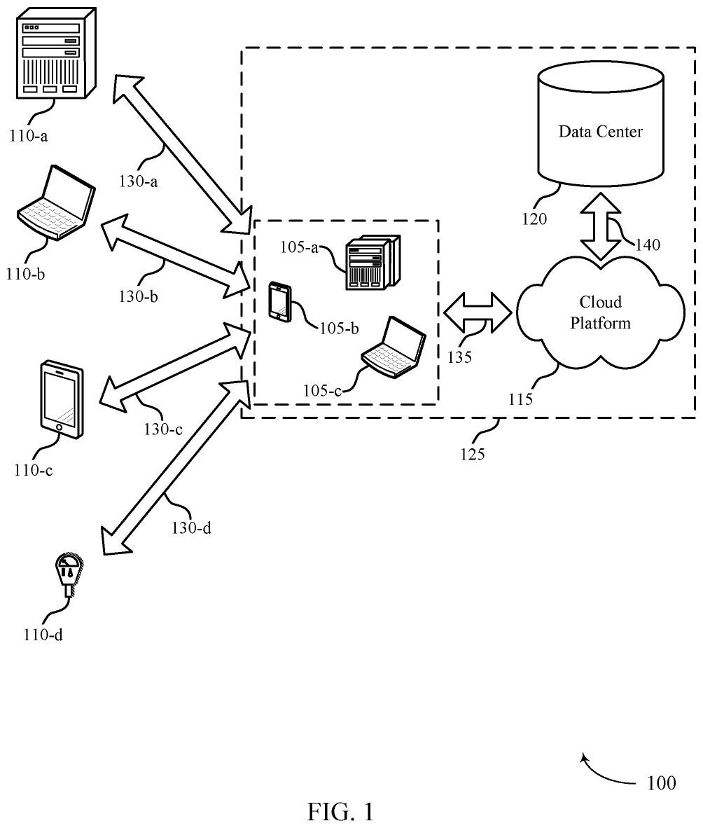

FIG. 1 illustrates an example of a system 100 for cloud computing that supports processing a natural language query using semantics machine learning in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135 and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

A cloud client 105 may be associated with a tenant of a multi-tenant database. The cloud client 105 may use a cloud platform 115 for multiple different applications, programs, or functionalities. For example, the cloud client 105 may store and manage data for different contacts 110, such as users, customers, and organizations, in the data center 120 via the cloud platform 115. Some examples of the different applications, programs, and functionalities provided by the cloud platform 115 may include data storage, searching, organizing, querying, reporting, and managing, among other features and tools.

In an example of functionality of the cloud platform 115, a cloud client 105 may request for the cloud client 105 to generate a report on a data query. The cloud client 105 may query the data center 120 in ways to extract meaningful information from the data. A user may be able to combine or cross-analyze multiple reports to further extract meaningful data and information. For example, analyzing a report may assist the tenant in future decision making for the cloud client's organization.

The cloud client 105 may select a dataset to analyze and apply one or more filters to the dataset to generate a data query. The cloud client may retrieve the data from a data storage (e.g., the data center 120) and generate the data query with the indicated dataset and filters. In some cases, the data query may be generated by a separate server and sent to the cloud platform 115, or the cloud platform 115 may include a server to generate the data query.

The cloud client may title the data query or provide some semantic description of the generated data query. In some cases, a report may include the data query and an appropriate title or description for the queried data. The description or title may be written in terms and conventions often used by the tenant. These reports, queries, semantic descriptors, interactions, and corresponding metadata may be stored in the data center 120.

The techniques described herein support interpreting a natural language query from a user and providing an appropriate data query to the user. The multi-tenant database may already have a large amount of information stored for each tenant, and this information may already be referred to with the terms, conventions, and language that each tenant naturally uses when refer to their data. Therefore, a server may utilize known relationships between stored data and the tenant-specific semantics to interpret the natural language query and return a corresponding data query. The metadata for reports may indicate which queries are relevant for a natural language query as well as how and which data objects to join to obtain the answer for the natural language query.

The subsystem 125 described herein may support using a tenant-specific machine learning model and tenant-specific data lineage map to interpret a natural language query. For example, the cloud platform 115 may support receiving a natural language query, applying a machine learning model and the data lineage to interpret what data the natural language query is asking for and where to find the requested data in the data center 120. The cloud platform 115 may retrieve a data query based on the interpretation of the natural language query and send the data query to the cloud client 105 over the network connection 135. In some cases, the cloud platform 115 may interpret or process the natural language query, or the data center 120 may interpret or process the natural language query.

The machine learning model may be trained on information stored in the data center 120. For example, the machine learning model may be trained on a set of reports generated by cloud clients 105. In some cases, the machine learning model may be trained on names and descriptions from list views, widget interactions and data, messaging and query titles via various web applications or interfaces. Each report, including a tenant-given title or description and a query for data objects of the tenant, may be used to train the tenant-specific machine learning model to understand questions and queries from the user in the language and terminology of the tenant's organization. Therefore, the reports may associate the tenant-specific language to the tenant's data. The machine learning model may learn from these associations to interpret the natural language queries and determine what fields, data objects, or data sets a natural language query is asking to query.

The natural language query may also be processed and interpreted based on a data lineage for the tenant's data. For example, a semantic graph may map the data lineage of data from multiple different data silos, applications, data sources etc., such that associations between data objects, fields, and databases of the tenant can be easily identified. By using the semantic graph and the machine learning model, the cloud platform 115 may parse through the natural language query, identify what the data the natural language query is asking for, and identify where that data is stored and what other data may be used to generate a corresponding data query.

The cloud platform 115, or a server associated with the cloud platform 115, may generate a semantic graph which indicates a data lineage for all of the tenant's data. The data lineage may show how the tenant's data is used and how different parts of the tenant's data are associated. The server may therefore leverage the machine learning model and data lineage for the tenant's data to understand what data is requested by a natural language query. With this automated process, a cloud client 105 may not have to create a book of synonyms for the server to understand the user's language and conventions, and the user may not have to manually link those terms to specific data sources to submit queries. Additionally, the cloud client 105 may not have to abide by a strict data querying structure or format when requesting a dataset. Users without a deep technical understanding of the data querying or report generating process may intuitively request data sets and receive meaningful information by using commonly used terms and phrases of the organization.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

In an example, a tenant may have used the cloud platform 115 and multiple services of the cloud platform 115 and already have a large amount of database stored in the data center 120. Users may have created several reports for data of the tenant, searched for data within the data center 120, discussed data over messaging systems, etc. The metadata of these queries, interactions, and reports may be stored in the data center 120. The cloud platform 115 may generate a machine learning model for the tenant based on the data in the data center 120. The machine learning model may be taught how users of the tenant's organization discuss the data and what words or phrases are associated with which data objects, fields, and databases in the data center 120. The cloud platform 115 may also build a semantic graph for the tenant's data, mapping the relationships between all of the tenant's data objects, data object fields, and databases.

A cloud contact 105 associated with the tenant may submit a natural language query via a user interface at a device. The cloud contact 105 may submit the natural language query to the cloud platform 115, which process the natural language query. The cloud platform 115 may parse the natural language query to estimate what data the natural language query is asking for. The cloud platform 115 may iteratively parse through the natural language query, starting with going character-by-character and slowly grouping characters or words together to predict the data set. In some cases, each iteration of parsing may refine the prediction, and the cloud platform 115 may identify different words or phrases which are associated with different data objects or fields until the cloud platform 115 has identified most likely data queries for the natural language query. The cloud platform 115 may use the associated tenant-specific machine learning model and data lineage to estimate the set of data queries which may correspond to the natural language query. The data queries may be sent back to the device of the user for display on the user interface. In some cases, the cloud platform 115 may indicate a ranking for the set of data queries, including a most-likely interpretation of the natural language query, and the cloud client 105 may indicate which of the data queries provides the correct dataset for the natural language query. In some cases, this feedback may further be used to refine the machine learning model.

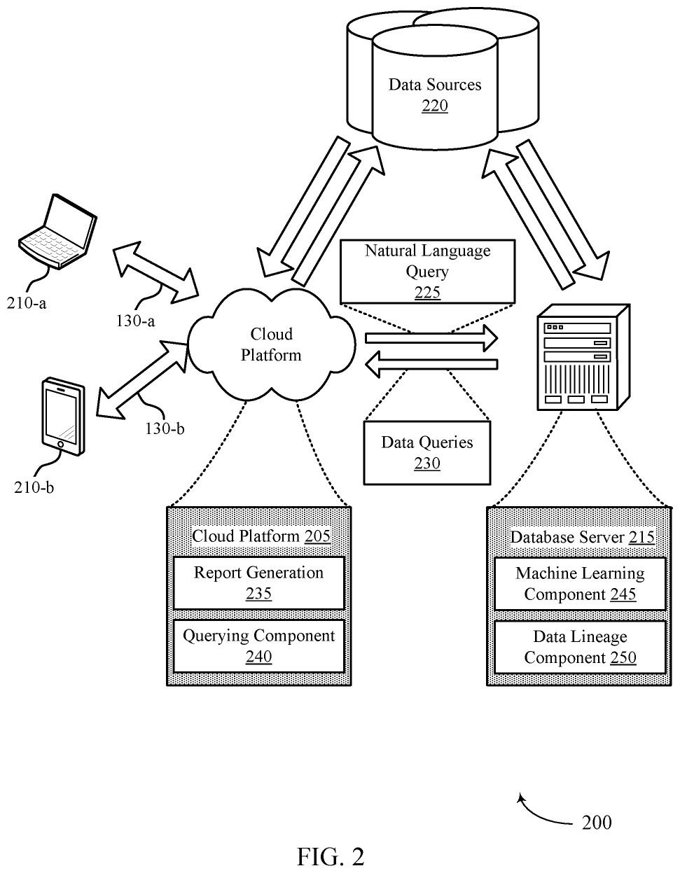

FIG. 2 illustrates an example of a subsystem 200 that supports processing a natural language query using semantics machine learning in accordance with aspects of the present disclosure. The subsystem 200 may include a cloud platform 205, one or more users 210, a database server 215, and one or more data sources 220. The users 210 may be examples of cloud clients 105 as described with reference to FIG. 1. The cloud platform 205, the database server 215, or both, may be examples of aspects of the cloud platform 115 as described with reference to FIG. 1. The data sources 220 may be an example of a data center 120 as described with reference to FIG. 1.

In an example, user 210-a may be associated with a tenant of a multi-tenant database. User 210-a, and other users associated with the tenant of the multi-tenant database, may use the cloud platform 205 for multiple different applications, programs, or functionalities. These applications, programs, and functionalities may have associated data and metadata for the tenant, which may be stored in the data sources 220. Some examples of the different applications, programs, and functionalities provided by the cloud platform 205 may include data storage, searching, organizing, querying, reporting, and managing, among other features and tools.

User 210-a may send a request for a data query to the cloud platform 205 on network link 130-a. User 210-a may query for data in a way that the queried data provides meaningful information or insight to user 210-a. User 210-a may be able to combine or cross-analyze multiple data queries to further extract meaningful data and information. For example, a data query may assist user 210-a with a future decision for an organization associated with the tenant. User 210-a may select a dataset to analyze and apply one or more filters to the dataset to generate a data query. Cloud platform 205 may retrieve the data from the data sources 220 and generate the data query with the indicated dataset and filters. For example, the querying component 240 may handle retrieving the data from the data sources 220 and generating the data query. In some examples, the data query may be generated by a separate server (e.g., the database server 215) and sent to the cloud platform 115, or the cloud platform 115 may include aspects of the database server 215 to generate the data query.

User 210-a may title the data query or provide some semantic description of the generated data query, creating a report. In some cases, a report may refer to a data query and a corresponding title or description of the queried data. The description or title may be written in terms and conventions often used by the tenant. These reports, queries, semantic descriptors, interactions, and corresponding metadata may be stored in the data center 120. In some cases, the report generation component 235 of the cloud platform 205 may generate the report and handle storing and managing metadata for the report.

Generally, the techniques described herein provide for a user 210 to send a natural language query for data to a cloud platform and receive one or more data queries in response. Therefore, the user 210 may not have to apply a rigorous formatting or have a technical knowledge of how to submit a data query while still receiving meaningful data sets. Further, the user 210 may use language and terms which are commonly used in the organization associated with the user 210 instead of using a pre-defined set of terms or conventions. In other systems, a user querying for data may receive an error if the user does not use terms which are known by the querying system, meaning that any terms or language which is unique to the user's associated organization may result in querying errors. In some systems, a user may manually construct a synonym book to match terms of the querying system to organization-specific terms, but this can be time consuming and inefficient. Additionally, the user may then map the organization-specific terms to specific data sets or data sources.

The techniques described herein support enhanced natural language querying by using a machine learning model and data lineage for a tenant. The cloud platform 205 and database server 215 may then interpret a natural language query from a user and provide an appropriate data query to the user. The data sources 220 may already have a large amount of information stored for the tenant, and this information may already be referred to with the terms, conventions, and language that users 210 associated with the tenant naturally use when refer to the data. Therefore, the cloud platform 205 may utilize known relationships between stored data and the tenant-specific semantics to interpret the natural language query and return a corresponding data query.

The metadata for reports may indicate which queries are relevant for a natural language query as well as how and which data objects to join to obtain the answer for the natural language query. Reports may include metadata which is used to construct a query with appropriately labeled parts.

The subsystem 200 may support using a tenant-specific machine learning model and tenant-specific data lineage map to interpret a natural language query. For example, the cloud platform 205 may receive a natural language query from a user 210. The cloud platform 205 may send a natural language query 225 to the database server 215. The database server 215 may send corresponding data queries 230 to the cloud platform 205, and the cloud platform 205 may display the corresponding data queries 230 to the requesting user 210 (e.g., via a user interface). In some cases, some functionality of the database server 215 may be performed by the cloud platform 205, or the cloud platform 205 may include aspects of the database server 215.

The database server 215 may apply a machine learning model and a semantic graph to determine what data the natural language query 225 is requesting and to determine a location of the requested data in the data sources 220. The machine learning model may be trained on information stored in the data sources 220. For example, the machine learning model may be trained on a set of reports generated by users 210. In some cases, machine learning model may be trained on names and descriptions from list views, widget interactions and data, messaging and query titles via various web applications or interfaces. Each report may include a tenant-given title or description and a query for data objects. Therefore, the reports may associate the tenant-specific language to the tenant's data. Based on this association, the reports may be used to train a tenant-specific machine learning model to understand questions and natural language queries from users 210 in the language and terminology of the tenant's organization. The machine learning component 245 of the database server 215 may train the machine learning model to learn from these associations and interpret the natural language queries, such that the database server 215 can determine what fields, data objects, or data sets a natural language query 225 is asking for.

The natural language query 225 may also be processed and interpreted based on a data lineage for the tenant's data. For example, a semantic graph may map the data lineage of data from multiple different data silos, applications, data sources etc., such that associations between data objects, fields, and databases of the tenant can be easily identified. By using the semantic graph and the machine learning model, the database server 215 may parse through the natural language query 225, identify what the data the natural language query 225 is asking for, and identify where that data is stored and what other data may be used to generate the corresponding data queries 230.

In some cases, the database server 215 may use the machine learning model to predict a report type associated with the natural language query 225. Predicting the report type may greatly narrow the possible data sets or data sources containing information relevant for the natural language query 225 to generate the data queries 230. The database server 215 may predict the report type associated with the natural language query 225 to determine which data objects or data fields are related to the natural language query 225 as well as how those data objects or data fields are related.

A data lineage component 250 of the database server 215 may generate a semantic graph which indicates a data lineage for the tenant's data. The data lineage may show how the tenant's data is used and how different parts of the tenant's data are associated. The database server 215 may therefore leverage the machine learning model and data lineage for the tenant's data to understand what data is requested by a natural language query. With this automated process, users 210 may not have to create a book of synonyms for the cloud platform 205 and database server 215 to understand the user's language and terms, and the users 210 may not have to manually link those terms to specific data sources to submit queries. Additionally, the users 210 may not have to abide by a strict data querying structure or format when requesting a dataset. Users without a deep technical understanding of the data querying or report generating process may intuitively request data sets and receive meaningful information by using commonly used terms and phrases of the organization.

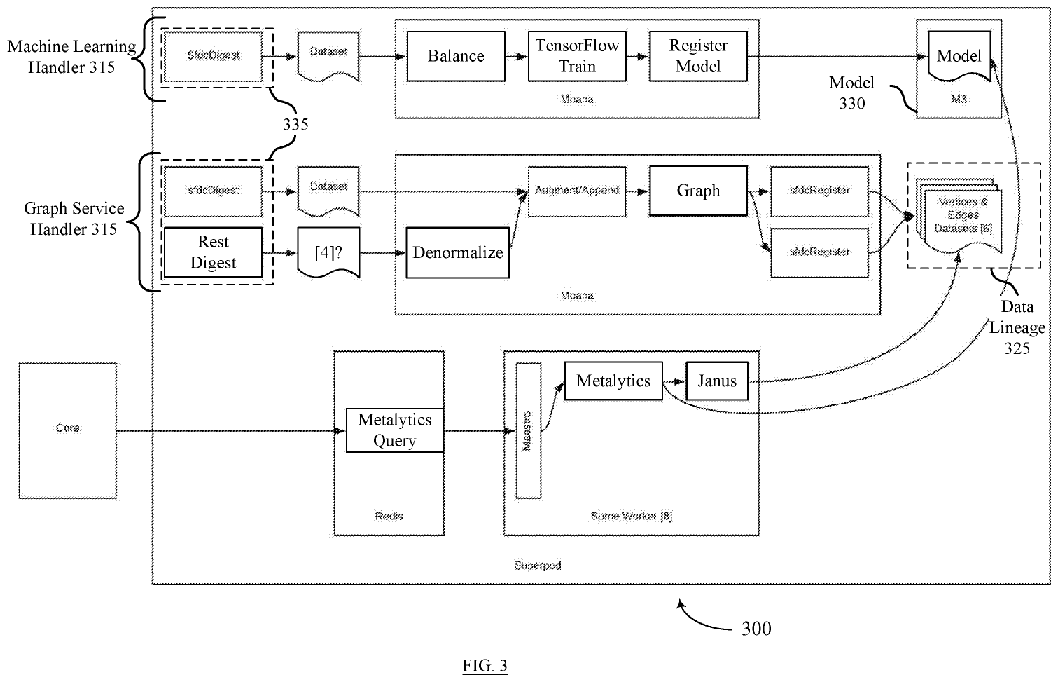

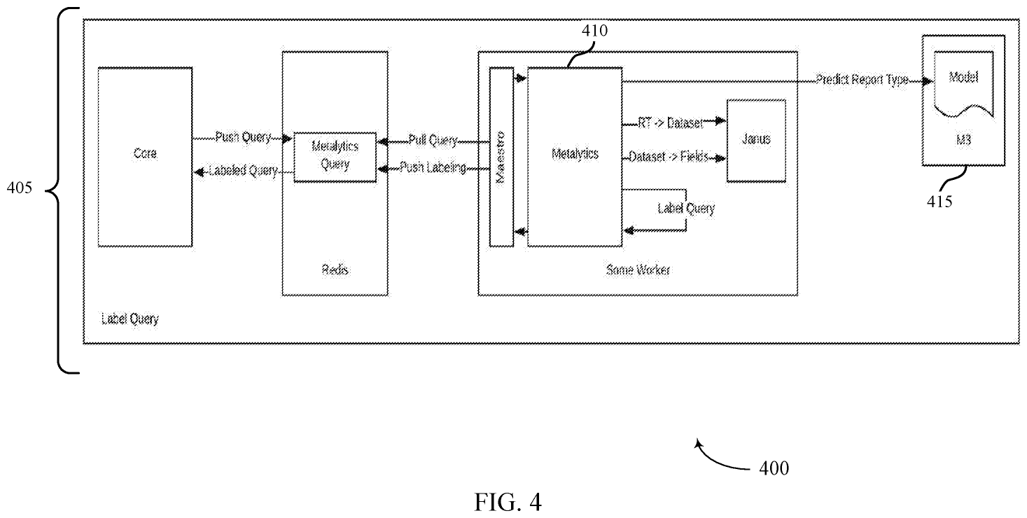

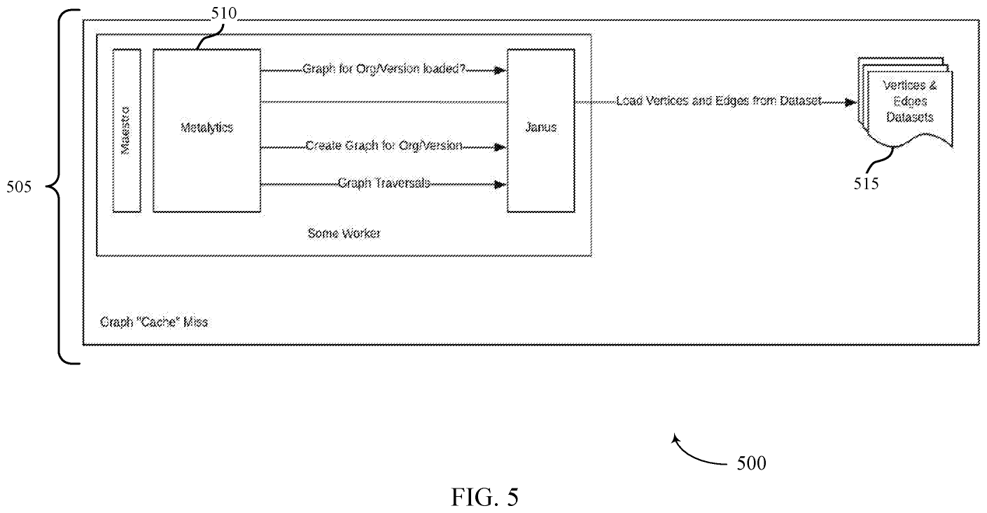

FIG. 3 illustrates an example of a natural language query procedure 300 that supports processing a natural language query using semantics machine learning in accordance with aspects of the present disclosure. The natural language query procedure 300 may include aspects of a machine learning service procedure 400 as described with reference to FIG. 4 and a graph service procedure 500 as described with reference to FIG. 5.

A user associated with a tenant of a multi-tenant database may send a natural language query to a superpod 305 implementing the natural language query procedure. A metalytics query component may send the natural language query to a natural language query analyzing component 310 which interfaces with a machine learning pipeline 315 and a graph service pipeline 320.

The machine learning pipeline 315 may train a tenant-specific machine learning model 330 based on the tenant's data. For example, the tenant may have several reports stored in one or more data sources 335. The data queries of these reports and the descriptions of the data queries may be used to train the machine learning model 330 on the tenant's language and how the language is used to describe the tenant's data. In some cases, the machine learning model 330 may be an example of a deep learning model, such as a short term memory model, a bag of words fed through a multi-layer perception, or a model leveraging Word2Vec. The superpod 305 may use the OA reports to train and infer a semantic layer without any additional input from users by using already-generated data and reports. In some cases, the TensorFlowTrain component may correspond to the training component of the machine learning pipeline 315 which trains the machine learning model using reports.

With semantics trained from reports, the superpod 305 may use a graph to implement the learned insights of the machine learning model 330 with a search feature. The graph service pipeline may generate a data lineage 325 using data sets from one or more data sources 335. The data lineage 325 may be based on a semantic graph and include multiple vertices and edges. The data lineage 325 may show how a tenant's data and metadata is related. In some cases, the vertices may correspond to data fields, data objects, or databases associated with the tenant's data. A vertex may include an asset identifier, an asset type, and metadata for the asset. Edges may have values corresponding to an association between two vertices. For example, an edge may include a “from” asset identifier, a “to” asset identifier, a type of the edge, and metadata for the edge.

The graph service pipeline 320 may extract data for the assets from multiple sources. For example, the graph service pipeline 320 may extract data from sources corresponding to reports, report types, data objects, and data sets. These assets may be transformed into two datasets, the edges and vertices. The graph service pipeline 320 may extract data from different sources using application programming interfaces associated with the sources. A graph may be built using the edges and vertices, showing relationships and associations in the tenant's data. In some cases, there may be an edge between fields of objects, objects, databases, datasets, or any combination thereof.

The superpod 305 may parse a natural language query to determine what data is being requested by a user. The natural language query may be parsed to identify words or characters corresponding to abbreviations, multiple different languages (e.g., English, Japanese, etc.), phrases, slang terminology, etc. The superpod 305 may tokenize and label using string distance. In some cases, the parsing may begin with a single character and iteratively expand.

For example, a user may want to query for deals by forecast category with an average amount of probability. The user may submit a natural language query of “deals by forecast cate gory with avg amount probability.” The query parser may parse, individually, each character of the natural language query and slow parse with larger character groups to estimate what data set the natural language query is related to. In one iteration, the query parser may group “forcast” and “categ” as separate fields. However, further iterations may correctly identify word groupings despite spelling errors. At a later iteration, the query parser may group “forcast categ ory” as a single field, having robustness against spelling errors or accidental character inserts (e.g., the misspelling of “forecast” and the extra space dividing the word “category”). The parser of the superpod 305 may use simple heuristics such as field type and proximity to disambiguate the natural language query.

When parsing a natural language query, the parser may identify fields and operations in the natural language query. In an example, a field may correspond to a data object or an asset. An operation may be something which is used to join or manipulate data, such as an aggregation, a minimum, a maximum, a sum, an average, or an organization (e.g., highest to lowest, etc.).

The superpod 305 may parse the natural language query and determine a report type associated with the requested data. For example, the superpod 305 may determine that the user is talking about data with a report type of “opportunities with products,” and the superpod 305 may determine that this corresponds to an “OpportunityLineItem” joining “Opportunities” and “Products,” which is being extracted to the superpod 305 from a specific dataset. So, from the report type, the superpod 305 may identify the relevant data objects (e.g., “SObjects”) and datasets to form data queries to start searches for relevant lenses or dashboards. The report type may be predicted based on how report types abstract how things are joined for specific processes. This may improve natural language query estimation, as the superpod 305 may perform the estimation without performing additional joins. Further, report types may serve as proxies for data objects and datasets, which may enable the transfer of model types (e.g., to other querying languages). Report types and datasets may be denormalized views of multiple objects which already consider join semantics.

Report type prediction may be similar to sentiment analysis with many (e.g., up to thousands) of sentiments instead of a more binary “positive” and “negative”. The superpod 305 may use a recurrent neural network or long short-term memory model with a deep learning framework. In some cases, the machine learning pipeline 315 may use additional layers and wrappers such as Dropout and Bidirectional. Results for machine learning report type prediction and report analysis may provide an approximation to a standard CRM-focused organization.

FIG. 4 illustrates an example of a machine learning service procedure 400 that supports processing a natural language query using semantics machine learning in accordance with aspects of the present disclosure. The machine learning service procedure 400 may include a machine learning pipeline 405, which may be an example of the machine learning pipeline 315 described with reference to FIG. 3. A metalytics component 410 of the machine learning pipeline 405 may perform report type prediction based on a natural language query. For example, the natural language query may be iteratively parsed to identify different fields, operations, etc. in the natural language query. The metalytics component 410 may have trained a machine learning model 415 on a set of reports generated by a user. The metalytics component 410 may label different characters or word groupings in the natural language query and estimate a report type for the natural language query from the labeling. The report type may then be used with the semantic graph to identify the appropriate datasets corresponding to the natural language query.

FIG. 5 illustrates an example of a graph service procedure 500 that supports processing a natural language query using semantics machine learning in accordance with aspects of the present disclosure. The graph service procedure 500 may include a graph service pipeline 505, which may be an example of the graph service pipeline 320 described with reference to FIG. 3. A graph may be built to interpret how data is represented in different data sources or databases. The graph may be built based on how the data is associated and point to each other. In some cases, the graph may be constructed to easily navigate between associated data.

A metalytics component 510 of the graph service pipeline 505 may receive a natural language query associated with a tenant. The metalytics component 510 may determine whether a graph for the tenant is loaded (e.g., in a cache) or not. If the graph is loaded, the metalytics component may use load the vertices and edges from the dataset and use the loaded vertices and edges to process the natural language query. For example, the graph may indicate relevant data silos or data sets to process the natural language query based on key words, characters, or phrases of the natural language query.

If the graph is not loaded, the metalytics component 510 may create a graph for the tenant. For example, the metalytics component 510 may determine report types associated with the natural language query and determine which data objects are associated with the determined report types. The metalytics component 510 may then identify how those data objects map to, or are referenced by, different data sets and data silos. The metalytics component 510 may build a comprehensive graph which may indicate a relationship between data objects which are queried for reports (e.g., based on report types) and data which is stored in other databases, data silos, or data sets.

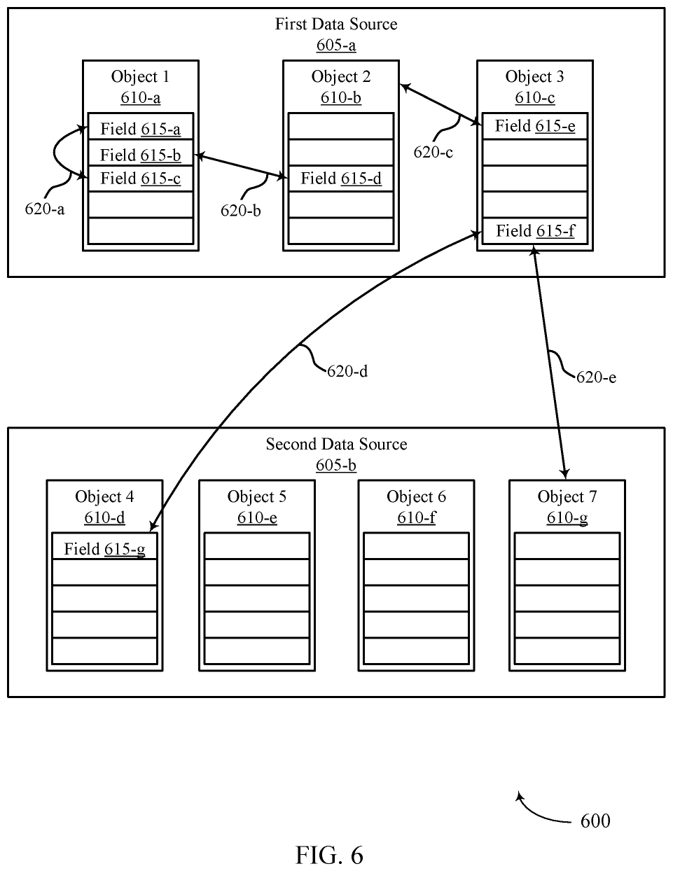

FIG. 6 illustrates an example of a semantic graph 600 that supports processing a natural language query using semantics machine learning in accordance with aspects of the present disclosure. The semantic graph 600 may show an example of a data lineage between different data objects, fields, and databases of a tenant. Generally, the semantic graph 600 may be represented in one or more tables. For example, the semantic graph 600 may correspond to one dataset of vertices and one dataset of edges. The semantic graph 600 may be a visual example of how edges may connect one or more vertices.

A semantic graph may be generated based on one or more data sources 605. For example, the semantic graph 600 may correspond to first data source 605-a and second data source 605-b. Data source 605-a may include a first data object 610-a, a second data object 610-b, and a third data object 610-c. Data source 605-b may include a fourth data object 610-d, a fifth data object 610-e, a sixth data object 610-f, and a seventh data object 610-g. Each data object 610 may include data fields 615. In some cases, the fields 615 for different data objects 610 may be the same or different, or different data objects 610 may have a different number of fields. A data object 610 may be an example of an SObject as described herein.

There may be associations between one or more data sources 605, data objects 610, data fields 615, or any combination thereof. In a first example, data field 615-a and data field 615-c may be vertices with an edge 620-a. In some cases, the edge 620-a may indicate that data field 615-a and data field 615-c of data object 610-a are often association. In a second example, there may be an edge 620-b between data field 615-b of data object 610-a and data field 615-d of data object 610-b. There may be an edge 620-c between data object 610-b and data object 616-e. In an example, there may be an edge 620-d between data field 615-f of data object 610-c and data field 615-g of data object 610-d and an edge 620-e between data field 615-f of data object 610-c and data object 610-g. In some cases, the relationships between data objects 610, data fields 615, and the data sources 605 may be based on a report type.

A database server may parse a natural language query and predict an associated report type with the natural language query. The database server may then identify data objects associated with that report type and identify related data objects and fields based on the associations as described herein. For example, if the database server identifies data field 615-g based on the predicted report type, the database server may also determine that data field 615-f could be related to the natural language query. The database server may then identify a set of database queries based on the predicted report type and semantic map.

In some cases, the data sources 605 may be examples of relational databases. These data sources 605 may store data objects and data fields which may be queried to generate reports based on a report type. The report type may be used to identify how the various data objects and data fields are related, and a server may provide the data objects and data fields which are related based on the report type.

In some cases, the data objects 610 and fields 615 may also be reference by, or mapped to, other data silos or data sets. For example, a data set may store a large amount of information, including at least all of the information of the data sources 605. In some cases, the data set 605 may be configured for efficient and fast querying. Using techniques described herein, a server may support processing a natural language query to predict a report type for the natural language query and identifying the data objects 610 and data fields 615 which are associated with the predicted report type. The server may then identify the data sets (e.g., configured for efficient querying) which are associated with these data objects 610 and data fields 615. The server may then efficiently query the data sets pointing to the data objects and data fields to quickly provide a result for the natural language query. As described herein, the relationships between the report types, data objects and fields, and data sets may be organized into a graph, showing the relationship between the data objects, data relationships, and data sets. Then, the server may process the natural language query to predict the report type, traverse the graph, and query the associated data sets linked from the graph.

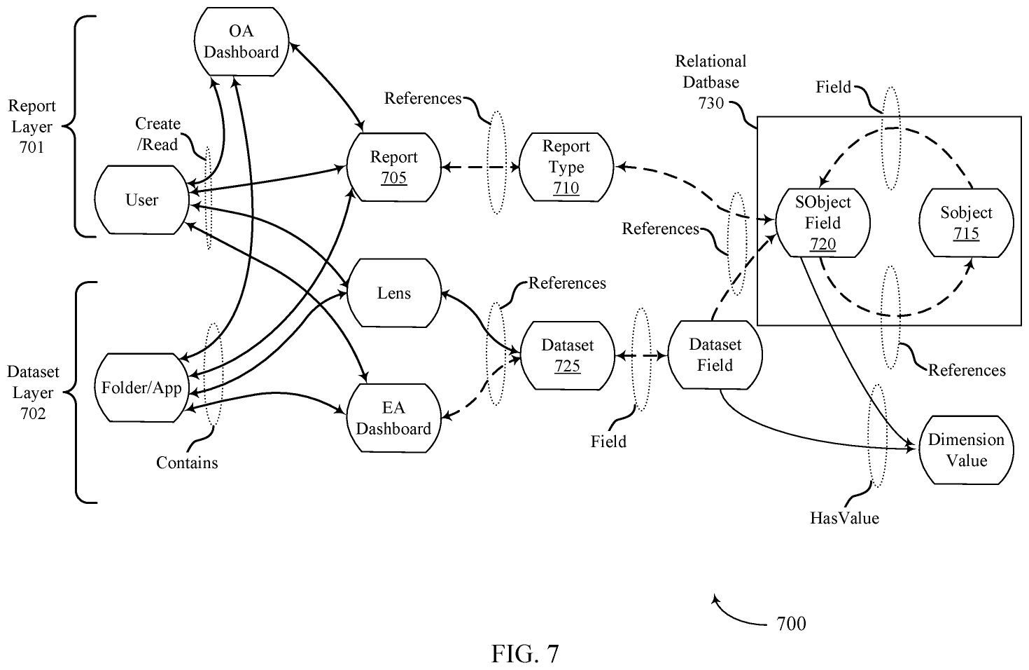

FIG. 7 illustrates an example of a natural language query processing graph 700 that supports processing a natural language query using semantics machine learning in accordance with aspects of the present disclosure.

The natural language query processing graph 700 may include a report layer 701 and a dataset layer 702. The report layer 701 may be associated with reports 705, such as operational analytics reports, which may be generated based on a requested report type 710. The database layer 702 may be associated with data which is stored in various datasets 725.

A user may select a report type 710 for a report 705 via a report dashboard, and the report layer may retrieve records to construct the report 705 based on the requested report type 710. Each report705 may be associated with a report type 710. The report type 710 indicates how things are joined, used or looked up for the report 705. The report 705 may be generated from data objects 715 and fields 720 in a database 730. There may be different kinds of records, such as opportunities, accounts, users, products, etc., which may be organized into different tables (e.g., data objects 715) and fields 720. These different tables and fields may be linked in different ways. For example, one account may be associated with multiple users and multiple opportunities, one user may be considered a manager of an account, etc. The report type 710 can indicate what are the key features, tables, and links between the information used to generate the report 705. Therefore, the user may request a set of records to generate the report 705 based on the report type 710 the user wants to create.

From the report type 710, a server may determine which data objects 715 are referenced in a report 705. The reports 705 may be generated based on data objects 715 and the fields of the data objects 715. The data objects 715 and data fields 720 may be stored in a database 730, such as a relational database.

The metadata and the report type may map to the data objects 715. In some cases, the mapping to the data objects 715 may also be based on language used in or used to describe the report 705, such as titles for different reports 705. The metadata, report types, and labeling of the reports may be used to construct a graph, where the graph links the reports 705 to the data objects 715. For example, using the report type, the language in the report may map to the tables (e.g., stored as the data objects 715) and fields 720. In some cases, the graph linking the reports 705 and report types 710 to the data objects 715 may be an example of some aspects of the data lineage as described herein.

The dataset layer 702 may include one or more datasets 725 and dataset fields. The datasets 725 and dataset fields may also include links to the data objects 715 and fields 720. Therefore, the data objects 715 may be common to both the report layer 701 and the dataset layer 702. For example, the data objects 715 and fields 720 may be linked to, first, the reports 705 and report types 710 and, second, the datasets 725 and data fields.

In some cases, querying processes using the dataset layer 702 may be faster than querying processes using the report layer 701. For example, the database 730 storing the data objects 720 and fields 725 may not be very efficient or quick to query, especially when a large amount of data is stored in the database 730. In some cases, a query using the dataset layer 702 may support querying significantly more data than a query made using the report layer 701. In some cases, the datasets 725 may form deformalized tables to aid in faster analytical queries for large data sets.

The techniques described herein support using both the report layer 701 and the dataset layer 702 to efficiently process natural language queries. When a server receives the natural language query, the report layer 701 may identify a report type 710 associated with the natural language query and identify various data objects 715 and fields 720 associated with the report type. The server may then identify which data sets 725 are associated with the identified data objects 715 and fields 720 retrieved based on the report type. For example, the report type 710 may point to the same objects 715 and fields 720 as the identified data sets 725. The server may then perform an efficient and fast query using the data sets 725.

Therefore, the server may process a natural language query to identify relevant data objects 715 and records, identify relevant data silos in the data sets 725 which also point to the relevant data objects 725 and records, and perform an efficient query using the data sets 725.

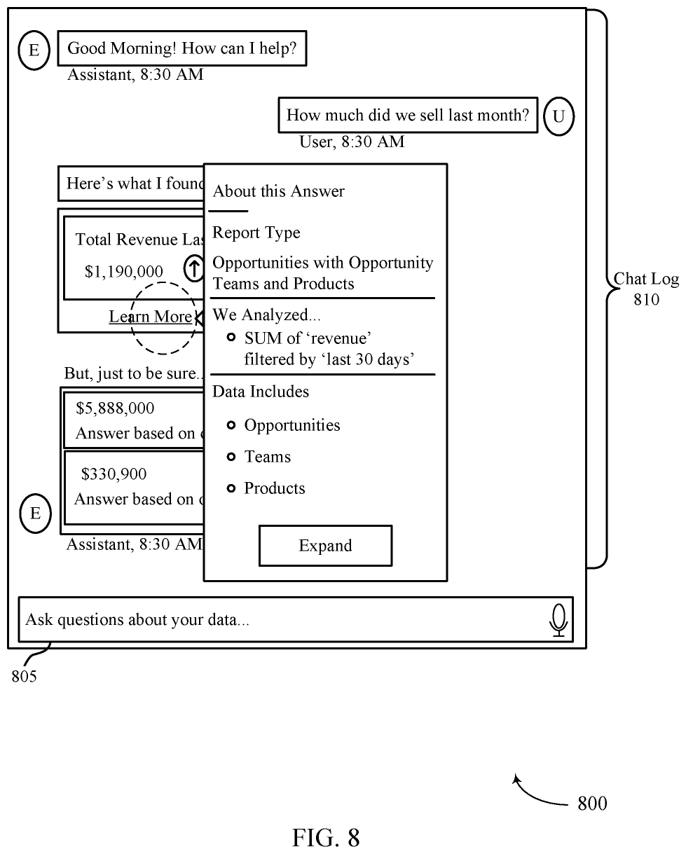

FIG. 8 shows a user interface 800 that supports processing a natural language query using semantics machine learning in accordance with aspects of the present disclosure. A user of a device may submit natural language queries via a device with the user interface 800. The user may be associated with a tenant of a multi-tenant database which has been using the cloud platform for data management. Therefore, there may be several data stores of data and metadata associated with the tenant which may be used to train a machine learning model and build a semantic graph for the tenant. The machine learning model and the semantic graph may be used to process a natural language query.

The user interface 800 may include a submit line 805 where the user can send the natural language query. Message exchanges between the user and an artificial intelligence (AI) assistant may be displayed and recorded in a chat log 810. Once the user sends the natural language query, the cloud platform may send the natural language query to a database server with a machine learning model component and a data lineage mapping component. For example, the natural language query may be processed by a superpod as described with reference to FIG. 3. The database server may identify a set of predicted data queries which may correspond to the natural language query.

The cloud platform may send messages on the user interface 800, the messages including text indicating the set of predicted data queries. In some cases, the set of predicted data queries may be ranked. For example, the user may receive a message displaying a “best guess” or highest ranked data query prediction. The ranking may correspond to an estimated likelihood that the data queries correspond to the natural language query. In some cases, the highest ranked data query prediction may include a graphic or more information than the other data query predictions. The other data query predictions may also be sent as a message.

A lower ranked data query may have an option to indicate the lower ranked data query as a closer prediction. For example, a lower ranked data query may be a better interpretation of the natural language query than the highest ranked data query. The user may then receive additional information for the selected data query. In some cases, this feedback may be applied to the machine learning model and data lineage map for the tenant.

In some cases, the user may be prompted with an option to be shown more information about how a data query was predicted or what data objects, fields, filters (e.g., date ranges), or operations (e.g., sum, average, etc.) were used to generate the data query. The user information may also include a report type for the data query. In some examples, the user interface may show samples of related data queries or other possible data which may be requested by the user. In some cases, the database server may generate data queries based on predicted data, which may be generated based on trends or data analysis. Data estimations or predictions may be indicated with the data query. Once the user receives a data query corresponding to the natural language query, the user may have an option to download, share, or save the data query. For example, the user may provide a title or description for the received data query. In some cases, the title or description may be used to further train the machine learning model.

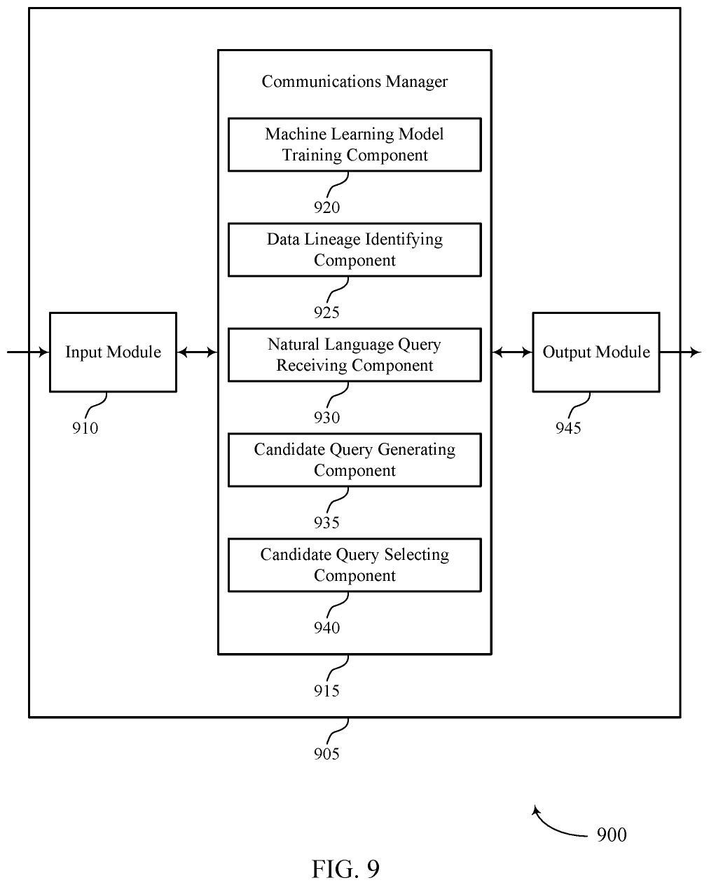

FIG. 9 shows a block diagram 900 of an apparatus 905 that supports processing a natural language query using semantics machine learning in accordance with aspects of the present disclosure. The apparatus 905 may include an input module 910, a communications manager 915, and an output module 945. The apparatus 905 may also include a processor. Each of these components may be in communication with one another (e.g., via one or more buses). In some cases, the apparatus 905 may be an example of a user terminal, a database server, or a system containing multiple computing devices.

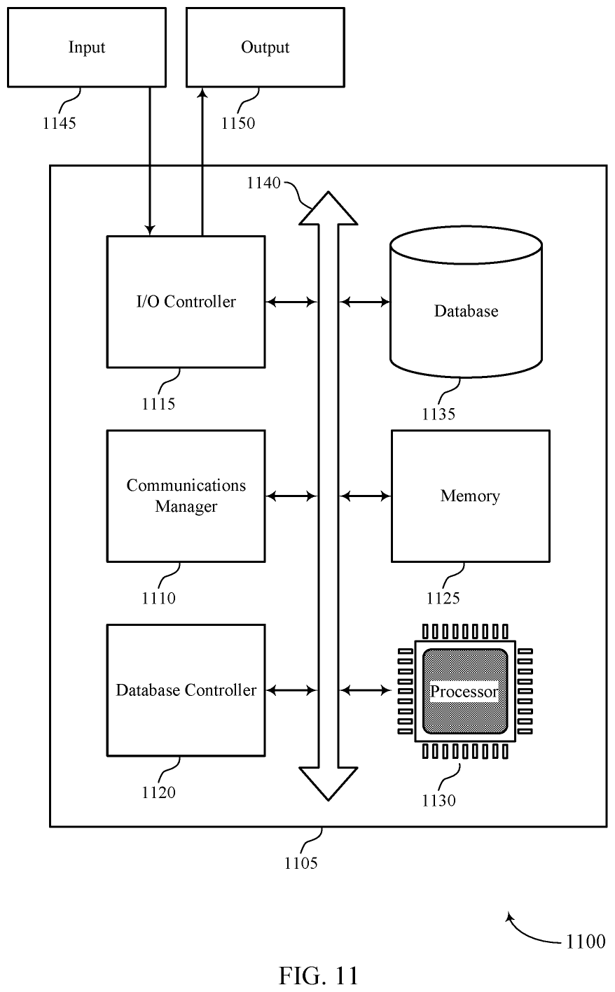

The input module 910 may manage input signals for the apparatus 905. For example, the input module 910 may identify input signals based on an interaction with a modem, a keyboard, a mouse, a touchscreen, or a similar device. These input signals may be associated with user input or processing at other components or devices. In some cases, the input module 910 may utilize an operating system such as iOS®, ANDROID®, MS-DOS®, MS-WINDOWS®, OS/2®, UNIX®, LINUX®, or another known operating system to handle input signals. The input module 910 may send aspects of these input signals to other components of the apparatus 905 for processing. For example, the input module 910 may transmit input signals to the communications manager 915 to support processing a natural language query using semantics machine learning. In some cases, the input module 910 may be a component of an input/output (I/O) controller 1115 as described with reference to FIG. 11.

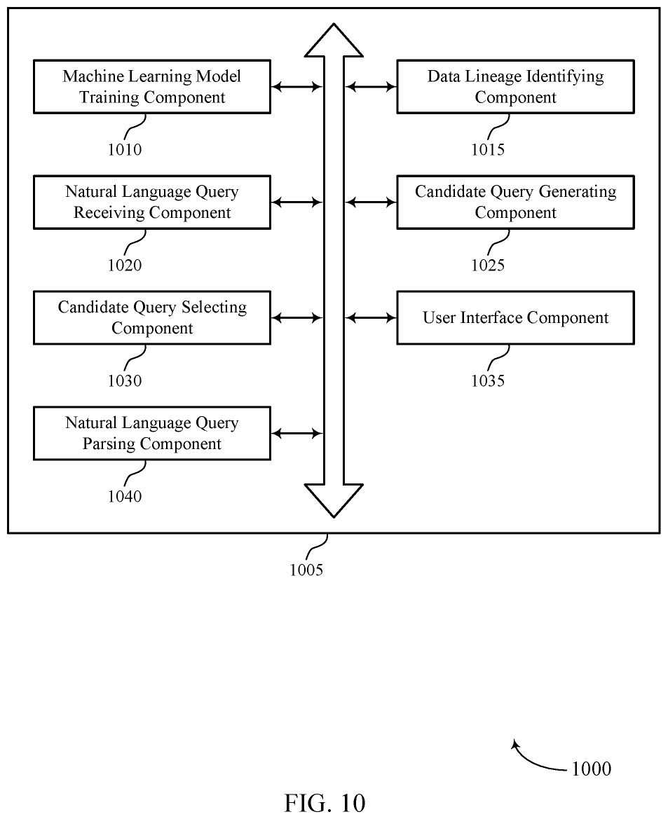

The communications manager 915 may include a machine learning model training component 920, a data lineage identifying component 925, a natural language query receiving component 930, a candidate query generating component 935, and a candidate query selecting component 940. The communications manager 915 may be an example of aspects of the communications manager 1005 or 1110 described with reference to FIGS. 10 and 11.

The communications manager 915 and/or at least some of its various sub-components may be implemented in hardware, software executed by a processor, firmware, or any combination thereof. If implemented in software executed by a processor, the functions of the communications manager 915 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The communications manager 915 and/or at least some of its various sub-components may be physically located at various positions, including being distributed such that portions of functions are implemented at different physical locations by one or more physical devices. In some examples, the communications manager 915 and/or at least some of its various sub-components may be a separate and distinct component in accordance with various aspects of the present disclosure. In other examples, the communications manager 915 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The machine learning model training component 920 may train a machine learning model on a set of reports generated by a tenant, where each report of the set of reports includes a title and a query for one or more data objects associated with the tenant.

The data lineage identifying component 925 may identify a data lineage for a data set associated with the tenant, where the data set is stored across a set of data sources and includes at least the one or more data objects. The natural language query receiving component 930 may receive a natural language query associated with the data set. The candidate query generating component 935 may generate a set of candidate queries from the natural language query based on the machine learning model and the data lineage. The candidate query selecting component 940 may select one or more of the candidate queries for display based on a ranking of the set of candidate queries.

The output module 945 may manage output signals for the apparatus 905. For example, the output module 945 may receive signals from other components of the apparatus 905, such as the communications manager 915, and may transmit these signals to other components or devices. In some specific examples, the output module 945 may transmit output signals for display in a user interface, for storage in a database or data store, for further processing at a server or server cluster, or for any other processes at any number of devices or systems. In some cases, the output module 945 may be a component of an I/O controller 1115 as described with reference to FIG. 11.

FIG. 10 shows a block diagram 1000 of a communications manager 1005 that supports processing a natural language query using semantics machine learning in accordance with aspects of the present disclosure. The communications manager 1005 may be an example of aspects of a communications manager 915 or a communications manager 1110 described herein. The communications manager 1005 may include a machine learning model training component 1010, a data lineage identifying component 1015, a natural language query receiving component 1020, a candidate query generating component 1025, a candidate query selecting component 1030, an user interface component 1035, and a natural language query parsing component 1040. Each of these modules may communicate, directly or indirectly, with one another (e.g., via one or more buses).

The machine learning model training component 1010 may train a machine learning model on a set of reports generated by a tenant, where each report of the set of reports includes a title and a query for one or more data objects associated with the tenant. In some examples, the machine learning model training component 1010 may identify a default machine learning model trained on a default set of reports, where the set of candidate queries are generated based on the default machine learning model. In some cases, the machine learning model is a deep learning model. In some cases, each report of the set of reports includes the one or more data objects and relationship between the one or more data objects.

The data lineage identifying component 1015 may identify a data lineage for a data set associated with the tenant, where the data set is stored across a set of data sources and includes at least the one or more data objects. In some examples, generating a semantics graph based on the data set associated with the tenant, where the semantics graph includes a set of vertices corresponding to the set of data sources, and where the semantics graph represents associations of the data set across the set of data sources.

The natural language query receiving component 1020 may receive a natural language query associated with the data set. The candidate query generating component 1025 may generate a set of candidate queries from the natural language query based on the machine learning model and the data lineage. The candidate query generating component 1025 may identify a set of data objects based on the natural language query, where the set of data objects are stored in a first data source of the set of data sources and associated with a second data source of the set of data sources based on the data lineage, and where the set of candidate queries are generated based on querying the second data source.

The candidate query selecting component 1030 may select one or more of the candidate queries for display based on a ranking of the set of candidate queries. The user interface component 1035 may display, on a user interface, a primary candidate query and one or more secondary candidate queries of the set of candidate queries, where the primary candidate query includes a higher ranking than the one or more secondary queries. In some examples, the user interface component 1035 may receive, via the user interface, an indication that a secondary candidate query from the one or more secondary candidate queries corresponds to the natural language query instead of the primary candidate query.

In some examples, the user interface component 1035 may update the machine learning model based on the received indication. In some examples, the user interface component 1035 may receive, via the user interface, an indication of a revision to the primary candidate query.

The natural language query parsing component 1040 may parse the natural language query with a per-character granularity during a first iteration of a set of iterations to generate a first candidate query of the set of candidate queries. In some examples, the natural language query parsing component 1040 may parse the natural language query with a character group granularity during subsequent iterations of the set of iterations to generate additional candidate queries of the set of candidate queries. In some examples, the natural language query parsing component 1040 may identify labels for one or more characters, character groups, or both, based on parsing the natural language query, where the labels include one or more data object fields, operations, directions, or a combination thereof. In some cases, the labels are identified based on an estimation of a misspelling in the one or more characters or one or more character groups.

FIG. 11 shows a diagram of a system 1100 including a device 1105 that supports processing a natural language query using semantics machine learning in accordance with aspects of the present disclosure. The device 1105 may be an example of or include the components of a database server or an apparatus 905 as described herein. The device 1105 may include components for bi-directional data communications including components for transmitting and receiving communications, including a communications manager 1110, an I/O controller 1115, a database controller 1120, memory 1125, a processor 1130, and a database 1135. These components may be in electronic communication via one or more buses (e.g., bus 1140).

The communications manager 1110 may be an example of a communications manager 915 or 1005 as described herein. For example, the communications manager 1110 may perform any of the methods or processes described above with reference to FIGS. 9 and 10. In some cases, the communications manager 1110 may be implemented in hardware, software executed by a processor, firmware, or any combination thereof.

The I/O controller 1115 may manage input signals 1145 and output signals 1150 for the device 1105. The I/O controller 1115 may also manage peripherals not integrated into the device 1105. In some cases, the I/O controller 1115 may represent a physical connection or port to an external peripheral. In some cases, the I/O controller 1115 may utilize an operating system such as iOS®, ANDROID®, MS-DOS®, MS-WINDOWS®, OS/2®, UNIX®, LINUX®, or another known operating system. In other cases, the I/O controller 1115 may represent or interact with a modem, a keyboard, a mouse, a touchscreen, or a similar device. In some cases, the I/O controller 1115 may be implemented as part of a processor. In some cases, a user may interact with the device 1105 via the I/O controller 1115 or via hardware components controlled by the I/O controller 1115.

The database controller 1120 may manage data storage and processing in a database 1135. In some cases, a user may interact with the database controller 1120. In other cases, the database controller 1120 may operate automatically without user interaction. The database 1135 may be an example of a single database, a distributed database, multiple distributed databases, a data store, a data lake, or an emergency backup database.

Memory 1125 may include random-access memory (RAM) and read-only memory (ROM). The memory 1125 may store computer-readable, computer-executable software including instructions that, when executed, cause the processor to perform various functions described herein. In some cases, the memory 1125 may contain, among other things, a basic input/output system (BIOS) which may control basic hardware or software operation such as the interaction with peripheral components or devices.

The processor 1130 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 1130 may be configured to operate a memory array using a memory controller. In other cases, a memory controller may be integrated into the processor 1130. The processor 1130 may be configured to execute computer-readable instructions stored in a memory 1125 to perform various functions (e.g., functions or tasks supporting processing a natural language query using semantics machine learning).

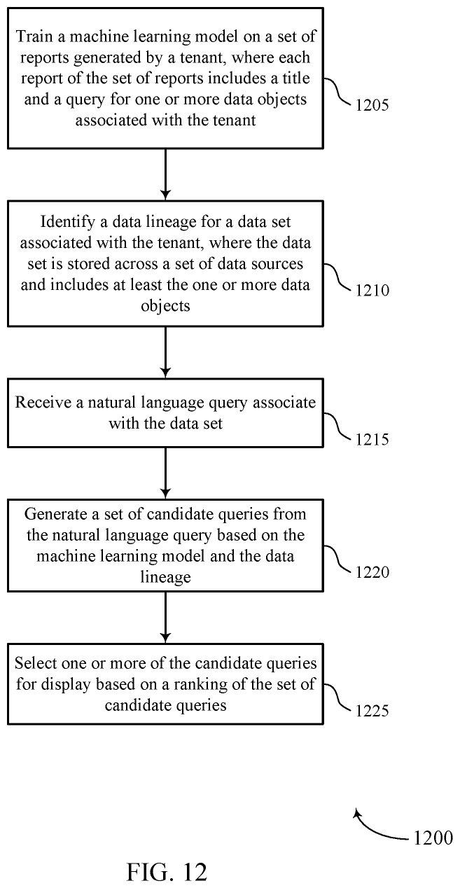

FIG. 12 shows a flowchart illustrating a method 1200 that supports processing a natural language query using semantics machine learning in accordance with aspects of the present disclosure. The operations of method 1200 may be implemented by a database server or its components as described herein. For example, the operations of method 1200 may be performed by a communications manager as described with reference to FIGS. 9 through 11. In some examples, a database server may execute a set of instructions to control the functional elements of the database server to perform the functions described below. Additionally or alternatively, a database server may perform aspects of the functions described below using special-purpose hardware.

At 1205, the database server may train a machine learning model on a set of reports generated by a tenant, where each report of the set of reports includes a title and a query for one or more data objects associated with the tenant. The operations of 1205 may be performed according to the methods described herein. In some examples, aspects of the operations of 1205 may be performed by a machine learning model training component as described with reference to FIGS. 9 through 11.

At 1210, the database server may identify a data lineage for a data set associated with the tenant, where the data set is stored across a set of data sources and includes at least the one or more data objects. The operations of 1210 may be performed according to the methods described herein. In some examples, aspects of the operations of 1210 may be performed by a data lineage identifying component as described with reference to FIGS. 9 through 11.

At 1215, the database server may receive a natural language query associated with the data set. The operations of 1215 may be performed according to the methods described herein. In some examples, aspects of the operations of 1215 may be performed by a natural language query receiving component as described with reference to FIGS. 9 through 11.

At 1220, the database server may generate a set of candidate queries from the natural language query based on the machine learning model and the data lineage. The operations of 1220 may be performed according to the methods described herein. In some examples, aspects of the operations of 1220 may be performed by a candidate query generating component as described with reference to FIGS. 9 through 11.

At 1225, the database server may select one or more of the candidate queries for display based on a ranking of the set of candidate queries. The operations of 1225 may be performed according to the methods described herein. In some examples, aspects of the operations of 1225 may be performed by a candidate query selecting component as described with reference to FIGS. 9 through 11.

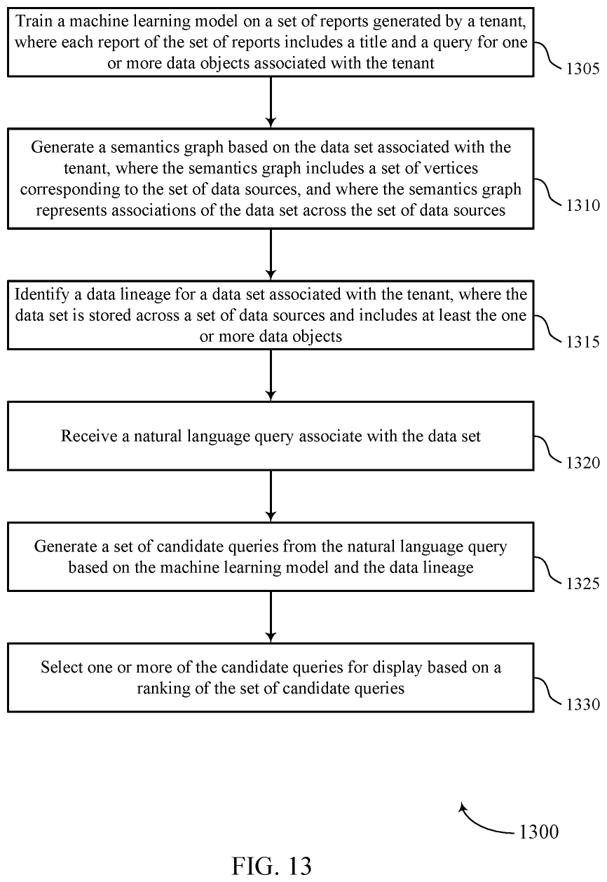

FIG. 13 shows a flowchart illustrating a method 1300 that supports processing a natural language query using semantics machine learning in accordance with aspects of the present disclosure. The operations of method 1300 may be implemented by a database server or its components as described herein. For example, the operations of method 1300 may be performed by a communications manager as described with reference to FIGS. 9 through 11. In some examples, a database server may execute a set of instructions to control the functional elements of the database server to perform the functions described below. Additionally or alternatively, a database server may perform aspects of the functions described below using special-purpose hardware.

At 1305, the database server may train a machine learning model on a set of reports generated by a tenant, where each report of the set of reports includes a title and a query for one or more data objects associated with the tenant. The operations of 1305 may be performed according to the methods described herein. In some examples, aspects of the operations of 1305 may be performed by a machine learning model training component as described with reference to FIGS. 9 through 11.

At 1310, the database server may generate a semantics graph based on the data set associated with the tenant, where the semantics graph includes a set of vertices corresponding to the set of data sources, and where the semantics graph represents associations of the data set across the set of data sources. The operations of 1310 may be performed according to the methods described herein. In some examples, aspects of the operations of 1310 may be performed by a data lineage identifying component as described with reference to FIGS. 9 through 11.

At 1315, the database server may identify a data lineage for a data set associated with the tenant, where the data set is stored across a set of data sources and includes at least the one or more data objects. The operations of 1315 may be performed according to the methods described herein. In some examples, aspects of the operations of 1315 may be performed by a data lineage identifying component as described with reference to FIGS. 9 through 11.

At 1320, the database server may receive a natural language query associated with the data set. The operations of 1320 may be performed according to the methods described herein. In some examples, aspects of the operations of 1320 may be performed by a natural language query receiving component as described with reference to FIGS. 9 through 11.

At 1325, the database server may generate a set of candidate queries from the natural language query based on the machine learning model and the data lineage. The operations of 1325 may be performed according to the methods described herein. In some examples, aspects of the operations of 1325 may be performed by a candidate query generating component as described with reference to FIGS. 9 through 11.

At 1330, the database server may select one or more of the candidate queries for display based on a ranking of the set of candidate queries. The operations of 1330 may be performed according to the methods described herein. In some examples, aspects of the operations of 1330 may be performed by a candidate query selecting component as described with reference to FIGS. 9 through 11.

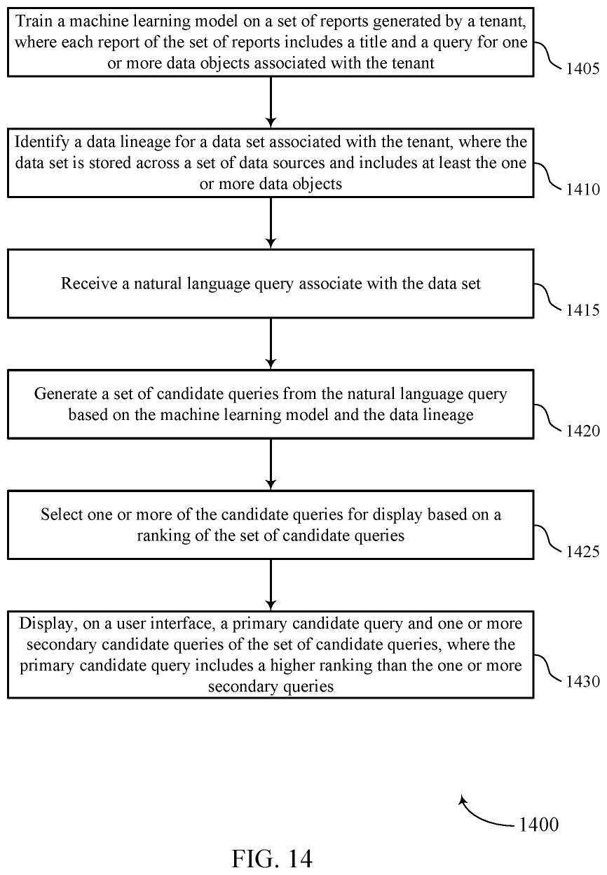

FIG. 14 shows a flowchart illustrating a method 1400 that supports processing a natural language query using semantics machine learning in accordance with aspects of the present disclosure. The operations of method 1400 may be implemented by a database server or its components as described herein. For example, the operations of method 1400 may be performed by a communications manager as described with reference to FIGS. 9 through 11. In some examples, a database server may execute a set of instructions to control the functional elements of the database server to perform the functions described below. Additionally or alternatively, a database server may perform aspects of the functions described below using special-purpose hardware.

At 1405, the database server may train a machine learning model on a set of reports generated by a tenant, where each report of the set of reports includes a title and a query for one or more data objects associated with the tenant. The operations of 1405 may be performed according to the methods described herein. In some examples, aspects of the operations of 1405 may be performed by a machine learning model training component as described with reference to FIGS. 9 through 11.

At 1410, the database server may identify a data lineage for a data set associated with the tenant, where the data set is stored across a set of data sources and includes at least the one or more data objects. The operations of 1410 may be performed according to the methods described herein. In some examples, aspects of the operations of 1410 may be performed by a data lineage identifying component as described with reference to FIGS. 9 through 11.

At 1415, the database server may receive a natural language query associated with the data set. The operations of 1415 may be performed according to the methods described herein. In some examples, aspects of the operations of 1415 may be performed by a natural language query receiving component as described with reference to FIGS. 9 through 11.

At 1420, the database server may generate a set of candidate queries from the natural language query based on the machine learning model and the data lineage. The operations of 1420 may be performed according to the methods described herein. In some examples, aspects of the operations of 1420 may be performed by a candidate query generating component as described with reference to FIGS. 9 through 11.

At 1425, the database server may select one or more of the candidate queries for display based on a ranking of the set of candidate queries. The operations of 1425 may be performed according to the methods described herein. In some examples, aspects of the operations of 1425 may be performed by a candidate query selecting component as described with reference to FIGS. 9 through 11.

At 1430, the database server may display, on a user interface, a primary candidate query and one or more secondary candidate queries of the set of candidate queries, where the primary candidate query includes a higher ranking than the one or more secondary queries. The operations of 1430 may be performed according to the methods described herein. In some examples, aspects of the operations of 1430 may be performed by an user interface component as described with reference to FIGS. 9 through 11.

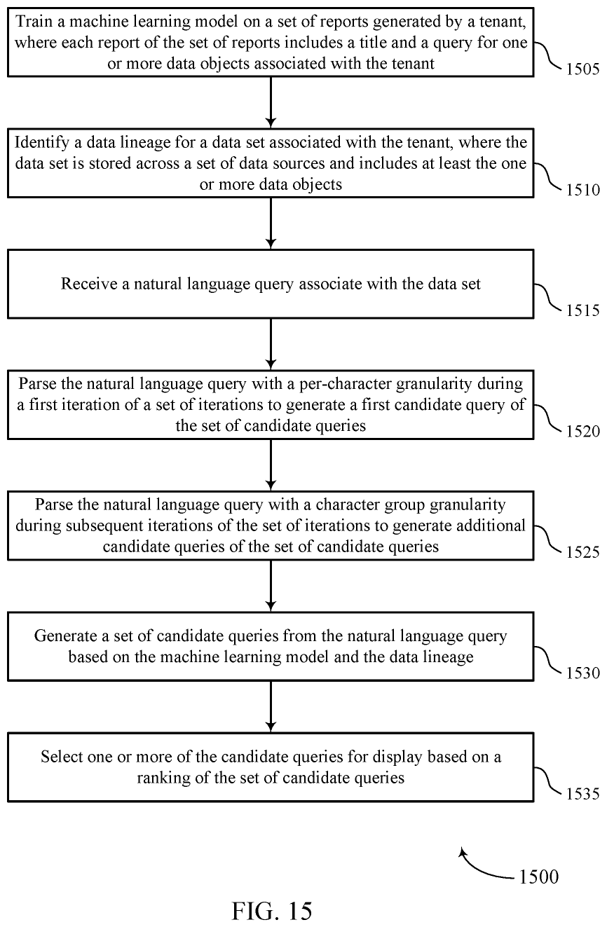

FIG. 15 shows a flowchart illustrating a method 1500 that supports processing a natural language query using semantics machine learning in accordance with aspects of the present disclosure. The operations of method 1500 may be implemented by a database server or its components as described herein. For example, the operations of method 1500 may be performed by a communications manager as described with reference to FIGS. 9 through 11. In some examples, a database server may execute a set of instructions to control the functional elements of the database server to perform the functions described below. Additionally or alternatively, a database server may perform aspects of the functions described below using special-purpose hardware.

At 1505, the database server may train a machine learning model on a set of reports generated by a tenant, where each report of the set of reports includes a title and a query for one or more data objects associated with the tenant. The operations of 1505 may be performed according to the methods described herein. In some examples, aspects of the operations of 1505 may be performed by a machine learning model training component as described with reference to FIGS. 9 through 11.

At 1510, the database server may identify a data lineage for a data set associated with the tenant, where the data set is stored across a set of data sources and includes at least the one or more data objects. The operations of 1510 may be performed according to the methods described herein. In some examples, aspects of the operations of 1510 may be performed by a data lineage identifying component as described with reference to FIGS. 9 through 11.

At 1515, the database server may receive a natural language query associated with the data set. The operations of 1515 may be performed according to the methods described herein. In some examples, aspects of the operations of 1515 may be performed by a natural language query receiving component as described with reference to FIGS. 9 through 11.

At 1520, the database server may parse the natural language query with a per-character granularity during a first iteration of a set of iterations to generate a first candidate query of the set of candidate queries. The operations of 1520 may be performed according to the methods described herein. In some examples, aspects of the operations of 1520 may be performed by a natural language query parsing component as described with reference to FIGS. 9 through 11.

At 1525, the database server may parse the natural language query with a character group granularity during subsequent iterations of the set of iterations to generate additional candidate queries of the set of candidate queries. The operations of 1525 may be performed according to the methods described herein. In some examples, aspects of the operations of 1525 may be performed by a natural language query parsing component as described with reference to FIGS. 9 through 11.

At 1530, the database server may generate a set of candidate queries from the natural language query based on the machine learning model and the data lineage. The operations of 1530 may be performed according to the methods described herein. In some examples, aspects of the operations of 1530 may be performed by a candidate query generating component as described with reference to FIGS. 9 through 11.

At 1535, the database server may select one or more of the candidate queries for display based on a ranking of the set of candidate queries. The operations of 1535 may be performed according to the methods described herein. In some examples, aspects of the operations of 1535 may be performed by a candidate query selecting component as described with reference to FIGS. 9 through 11.

A method of natural language query processing is described. The method may include training a machine learning model on a set of reports generated by a tenant, where each report of the set of reports includes a title and a query for one or more data objects associated with the tenant, identifying a data lineage for a data set associated with the tenant, where the data set is stored across a set of data sources and includes at least the one or more data objects, receiving a natural language query associated with the data set, generating a set of candidate queries from the natural language query based on the machine learning model and the data lineage, and selecting one or more of the candidate queries for display based on a ranking of the set of candidate queries.

An apparatus for natural language query processing is described. The apparatus may include a processor, memory coupled with the processor, and instructions stored in the memory. The instructions may be executable by the processor to cause the apparatus to train a machine learning model on a set of reports generated by a tenant, where each report of the set of reports includes a title and a query for one or more data objects associated with the tenant, identify a data lineage for a data set associated with the tenant, where the data set is stored across a set of data sources and includes at least the one or more data objects, receive a natural language query associated with the data set, generate a set of candidate queries from the natural language query based on the machine learning model and the data lineage, and select one or more of the candidate queries for display based on a ranking of the set of candidate queries.

Another apparatus for natural language query processing is described. The apparatus may include means for training a machine learning model on a set of reports generated by a tenant, where each report of the set of reports includes a title and a query for one or more data objects associated with the tenant, identifying a data lineage for a data set associated with the tenant, where the data set is stored across a set of data sources and includes at least the one or more data objects, receiving a natural language query associated with the data set, generating a set of candidate queries from the natural language query based on the machine learning model and the data lineage, and selecting one or more of the candidate queries for display based on a ranking of the set of candidate queries.

A non-transitory computer-readable medium storing code for natural language query processing is described. The code may include instructions executable by a processor to train a machine learning model on a set of reports generated by a tenant, where each report of the set of reports includes a title and a query for one or more data objects associated with the tenant, identify a data lineage for a data set associated with the tenant, where the data set is stored across a set of data sources and includes at least the one or more data objects, receive a natural language query associated with the data set, generate a set of candidate queries from the natural language query based on the machine learning model and the data lineage, and select one or more of the candidate queries for display based on a ranking of the set of candidate queries.

In some examples of the method, apparatuses, and non-transitory computer-readable medium described herein, identifying the data lineage further may include operations, features, means, or instructions for generating a semantics graph based on the data set associated with the tenant, where the semantics graph includes a set of vertices corresponding to the set of data sources, and where the semantics graph represents associations of the data set across the set of data sources.

Some examples of the method, apparatuses, and non-transitory computer-readable medium described herein may further include operations, features, means, or instructions for displaying, on a user interface, a primary candidate query and one or more secondary candidate queries of the set of candidate queries, where the primary candidate query includes a higher ranking than the one or more secondary queries.

Some examples of the method, apparatuses, and non-transitory computer-readable medium described herein may further include operations, features, means, or instructions for receiving, via the user interface, an indication that a secondary candidate query from the one or more secondary candidate queries corresponds to the natural language query instead of the primary candidate query, and updating the machine learning model based on the received indication.

Some examples of the method, apparatuses, and non-transitory computer-readable medium described herein may further include operations, features, means, or instructions for identifying a set of data objects based on the natural language query, where the set of data objects are stored in a first data source of the set of data sources and associated with a second data source of the set of data sources based on the data lineage, and where the set of candidate queries are generated based on querying the second data source.

Some examples of the method, apparatuses, and non-transitory computer-readable medium described herein may further include operations, features, means, or instructions for receiving, via the user interface, an indication of a revision to the primary candidate query, and updating the machine learning model based on the received indication.

Some examples of the method, apparatuses, and non-transitory computer-readable medium described herein may further include operations, features, means, or instructions for parsing the natural language query with a per-character granularity during a first iteration of a set of iterations to generate a first candidate query of the set of candidate queries, and parsing the natural language query with a character group granularity during subsequent iterations of the set of iterations to generate additional candidate queries of the set of candidate queries.

Some examples of the method, apparatuses, and non-transitory computer-readable medium described herein may further include operations, features, means, or instructions for identifying labels for one or more characters, character groups, or both, based on parsing the natural language query, where the labels include one or more data object fields, operations, directions, or a combination thereof.

In some examples of the method, apparatuses, and non-transitory computer-readable medium described herein, the labels may be identified based on an estimation of a misspelling in the one or more characters or one or more character groups.

In some examples of the method, apparatuses, and non-transitory computer-readable medium described herein, the machine learning model may be a deep learning model.

Some examples of the method, apparatuses, and non-transitory computer-readable medium described herein may further include operations, features, means, or instructions for identifying a default machine learning model trained on a default set of reports, where the set of candidate queries may be generated based on the default machine learning model.

In some examples of the method, apparatuses, and non-transitory computer-readable medium described herein, each report of the set of reports includes the one or more data objects and relationship between the one or more data objects.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for natural language query processing, comprising:
training a machine learning model on a set of reports generated by a tenant, wherein each report of the set of reports comprises a title and a query for one or more data objects associated with the tenant;
identifying a data lineage for a data set associated with the tenant, wherein the data set is stored across a plurality of data sources and comprises at least the one or more data objects;
receiving a natural language query associated with the data set;
generating a plurality of candidate queries from the natural language query based at least in part on the machine learning model and the data lineage; and
selecting one or more of the candidate queries for display based at least in part on a ranking of the plurality of candidate queries.

2. The method of claim 1, wherein identifying the data lineage further comprises:
generating a semantics graph based at least in part on the data set associated with the tenant, wherein the semantics graph comprises a set of vertices corresponding to the plurality of data sources, and wherein the semantics graph represents associations of the data set across the plurality of data sources.

3. The method of claim 1, further comprising:
displaying, on a user interface, a primary candidate query and one or more secondary candidate queries of the plurality of candidate queries, wherein the primary candidate query comprises a higher ranking than the one or more secondary queries.

4. The method of claim 3, further comprising:
receiving, via the user interface, an indication that a secondary candidate query from the one or more secondary candidate queries corresponds to the natural language query instead of the primary candidate query; and
updating the machine learning model based at least in part on the received indication.

5. The method of claim 3, further comprising:
receiving, via the user interface, an indication of a revision to the primary candidate query; and
updating the machine learning model based at least in part on the received indication.

6. The method of claim 1, further comprising:
identifying a set of data objects based at least in part on the natural language query, wherein the set of data objects are stored in a first data source of the plurality of data sources and associated with a second data source of the plurality of data sources based at least in part on the data lineage, and wherein the plurality of candidate queries are generated based at least in part on querying the second data source.

7. The method of claim 1, further comprising:
parsing the natural language query with a per-character granularity during a first iteration of a plurality of iterations to generate a first candidate query of the plurality of candidate queries; and
parsing the natural language query with a character group granularity during subsequent iterations of the plurality of iterations to generate additional candidate queries of the plurality of candidate queries.

8. The method of claim 7, wherein:
identifying labels for one or more characters, character groups, or both, based at least in part on parsing the natural language query, wherein the labels comprise one or more data object fields, operations, directions, or a combination thereof.

9. The method of claim 7, wherein the labels are identified based at least in part on an estimation of a misspelling in the one or more characters or one or more character groups.

10. The method of claim 1, wherein the machine learning model is a deep learning model.

11. The method of claim 1, further comprising:
identifying a default machine learning model trained on a default set of reports, wherein the plurality of candidate queries are generated based at least in part on the default machine learning model.

12. The method of claim 1, wherein each report of the set of reports comprises the one or more data objects and relationship between the one or more data objects.

13. An apparatus for natural language query processing, comprising:
a processor,
memory coupled with the processor; and
instructions stored in the memory and executable by the processor to cause the apparatus to:
train a machine learning model on a set of reports generated by a tenant, wherein each report of the set of reports comprises a title and a query for one or more data objects associated with the tenant;
identify a data lineage for a data set associated with the tenant, wherein the data set is stored across a plurality of data sources and comprises at least the one or more data objects;
receive a natural language query associated with the data set;
generate a plurality of candidate queries from the natural language query based at least in part on the machine learning model and the data lineage; and
select one or more of the candidate queries for display based at least in part on a ranking of the plurality of candidate queries.

14. The apparatus of claim 13, wherein the instructions to identify the data lineage further are executable by the processor to cause the apparatus to:
generate a semantics graph based at least in part on the data set associated with the tenant, wherein the semantics graph comprises a set of vertices corresponding to the plurality of data sources, and wherein the semantics graph represents associations of the data set across the plurality of data sources.

15. The apparatus of claim 13, wherein the instructions are further executable by the processor to cause the apparatus to:
display, on a user interface, a primary candidate query and one or more secondary candidate queries of the plurality of candidate queries, wherein the primary candidate query comprises a higher ranking than the one or more secondary queries.

16. The apparatus of claim 15, wherein the instructions are further executable by the processor to cause the apparatus to:
receive, via the user interface, an indication that a secondary candidate query from the one or more secondary candidate queries corresponds to the natural language query instead of the primary candidate query; and
update the machine learning model based at least in part on the received indication.

17. The apparatus of claim 15, wherein the instructions are further executable by the processor to cause the apparatus to:
receive, via the user interface, an indication of a revision to the primary candidate query; and
update the machine learning model based at least in part on the received indication.

18. The apparatus of claim 13, wherein the instructions are further executable by the processor to cause the apparatus to:
parse the natural language query with a per-character granularity during a first iteration of a plurality of iterations to generate a first candidate query of the plurality of candidate queries; and
parse the natural language query with a character group granularity during subsequent iterations of the plurality of iterations to generate additional candidate queries of the plurality of candidate queries.

19. The apparatus of claim 18, wherein identifying labels for one or more characters, character groups, or both, based at least in part on parsing the natural language query, wherein the labels comprise one or more data object fields, operations, directions, or a combination thereof.

20. A non-transitory computer-readable medium storing code for natural language query processing, the code comprising instructions executable by a processor to:
train a machine learning model on a set of reports generated by a tenant, wherein each report of the set of reports comprises a title and a query for one or more data objects associated with the tenant;
identify a data lineage for a data set associated with the tenant, wherein the data set is stored across a plurality of data sources and comprises at least the one or more data objects;
receive a natural language query associated with the data set;
generate a plurality of candidate queries from the natural language query based at least in part on the machine learning model and the data lineage; and
select one or more of the candidate queries for display based at least in part on a ranking of the plurality of candidate queries.
